(19) United States
(12) Patent Application Publication
(10) Pub. No.: US 2025/0358005 A1
(43) Pub. Date: Nov. 20, 2025

(54) OPTICAL WIRELESS COMMUNICATION SYSTEM AND RECEIVING DEVICE

(71) Applicant: TOYOTA JIDOSHA KABUSHIKI KAISHA, Toyota-shi Aichi-ken (JP)

(72) Inventors: Shintaro SHIBA, Bunkyo-ku Tokyo-to (JP); Quan KONG, Toshima-ku Tokyo-to (JP); Norimasa KOBORI, Nakano-ku Tokyo-to (JP)

(73) Assignee: TOYOTA JIDOSHA KABUSHIKI KAISHA, Toyota-shi Aichi-ken (JP)

(21) Appl. No.: 19/176,779

(22) Filed: Apr. 11, 2025

(30) Foreign Application Priority Data
May 15, 2024 (JP) 2024-079631

(51) Int. Cl. H04B 10/073; G06T 7/246; G06T 7/80

(52) U.S. Cl. CPC H04B 10/0731; G06T 7/246; G06T 7/80

(57) ABSTRACT

An optical wireless communication system includes a plurality of light sources, a receiving device including an event camera, and an information processing device. Each light source transmits an optical signal. The receiving device receives the optical signal through the event camera. The optical signal includes position specifying information, for specifying a position of a transmission source of the optical signal in an absolute coordinate system. The information processing device estimates a position and an orientation of the event camera in an absolute coordinate system, using a light source image position and a light source absolute position.

### CROSS REFERENCE TO RELATED APPLICATION

This application claims priority to Japanese Patent Application No. 2024-079631 filed on May 15, 2024, the entire contents of which are incorporated by reference herein.

### TECHNICAL FIELD

The present disclosure relates to an optical wireless communication system and a receiving device used for estimation of an absolute position and orientation of a camera.

### BACKGROUND ART

As an existing technique, a technique is known in which a plurality of blinking light sources and a camera are used to estimate the position and orientation of the camera.

Patent Literature 1 discloses an optical marker system that estimates the position and orientation of a camera. The camera shoots an image including a blinking light emitter (LED marker) and a non-blinking feature point. The optical marker system specifies the LED marker based on a blinking pattern detected from the image and estimates the position and posture of the camera from the three-dimensional position etc. of the specified LED marker.

### LIST OF RELATED ART

Patent Literature 1: Japanese Patent Application Laid-Open No. 2009-033366

### SUMMARY

The optical marker system disclosed in Patent Literature 1 estimates the position and orientation of a camera using a normal camera (frame-based camera). A frame-based sensor built in a normal camera outputs information of all pixels as an image at a predetermined time interval (frame rate), and thus the amount of data tends to be large. Therefore, an information processing device with high process performance is required in order to process an obtained image.

A purpose of the present disclosure is to provide a technique capable of estimating a camera position even when an information processing device does not have particularly high process performance.

A first aspect relates to an optical wireless communication system.

The optical wireless communication system includes a plurality of light sources, a receiving device including an event camera, and an information processing device.

Each light source is configured to transmit an optical wireless communication signal.

The receiving device is configured to receive the optical wireless communication signal through the event camera.

The optical wireless communication signal includes position specifying information, for specifying a position of a transmission source of the optical wireless communication signal in an absolute coordinate system.

The information processing device is configured to:
acquire a light source image position indicating a position of each light source projected on an image plane coordinate system of an image plane obtained by the event camera, by specifying a signal region of the optical wireless communication signal on the image plane coordinate system;
acquire a light source absolute position indicating a position of each light source in the absolute coordinate system, based on the position specifying information included in the optical wireless communication signal; and
estimate a position and an orientation of the event camera in the absolute coordinate system, using the light source image position and the light source absolute position.

A second aspect relates to a receiving device.

The receiving device includes an event camera and an information processing device, configured to receive an optical wireless communication signal transmitted from each of a plurality of light sources through the event camera.

The optical wireless communication signal includes position specifying information, for specifying a position of a transmission source of the optical wireless communication signal in an absolute coordinate system.

The information processing device is configured to:
acquire a light source image position indicating a position of each light source projected on an image plane coordinate system, by specifying a signal region of the optical wireless communication signal on the image plane coordinate system of an image plane obtained by the event camera;
acquire a light source absolute position indicating a position of each light source in the absolute coordinate system, based on the position specifying information included in the optical wireless communication signal; and
estimate a position and an orientation of the event camera in the absolute coordinate system, using the light source image position and the light source absolute position.

The receiving device in the optical wireless communication system includes the event camera. The event camera detects only information on pixels in which luminance changes equal to or greater than the threshold occurred, and outputs the information as event data. Therefore, the receiving device can efficiently detect the optical signal, and the data amount of the event data is smaller than the image data amount output by a normal camera. This means that the optical wireless communication system can estimate the camera position even if the information processing device does not have a particularly high process performance.

### BRIEF DESCRIPTION OF DRAWINGS

FIG. 1 is a diagram showing an overview of an optical wireless communication system according to the present embodiment;

FIG. 2 is a perspective view showing a geometrical relationship between a light source absolute position and a light source image position;

FIG. 3A is a schematic diagram showing a process of acquiring a light source image position;

FIG. 3B is another schematic diagram showing a process of acquiring a light source image position;

FIG. 4 is a graph showing data frequencies of an optical signal and noise;

FIG. 5A is a schematic diagram showing some examples of light source absolute position acquisition;

FIG. 5B is another schematic diagram showing some examples of light source absolute position acquisition;

FIG. 6A is a diagram showing image planes before light source image position acquisition and the light source absolute position acquisition are performed;

FIG. 6B is a diagram showing image planes after light source image position acquisition and the light source absolute position acquisition are performed;

FIG. 7 is a diagram showing a comparative example;

FIG. 8 is a block diagram showing a first configuration example of the optical wireless communication system;

FIG. 9 is a block diagram showing a second configuration example of the optical wireless communication system.

### DETAILED DESCRIPTION

Embodiments of the present disclosure will be described with reference to the drawings.

### 1. Basic Configuration

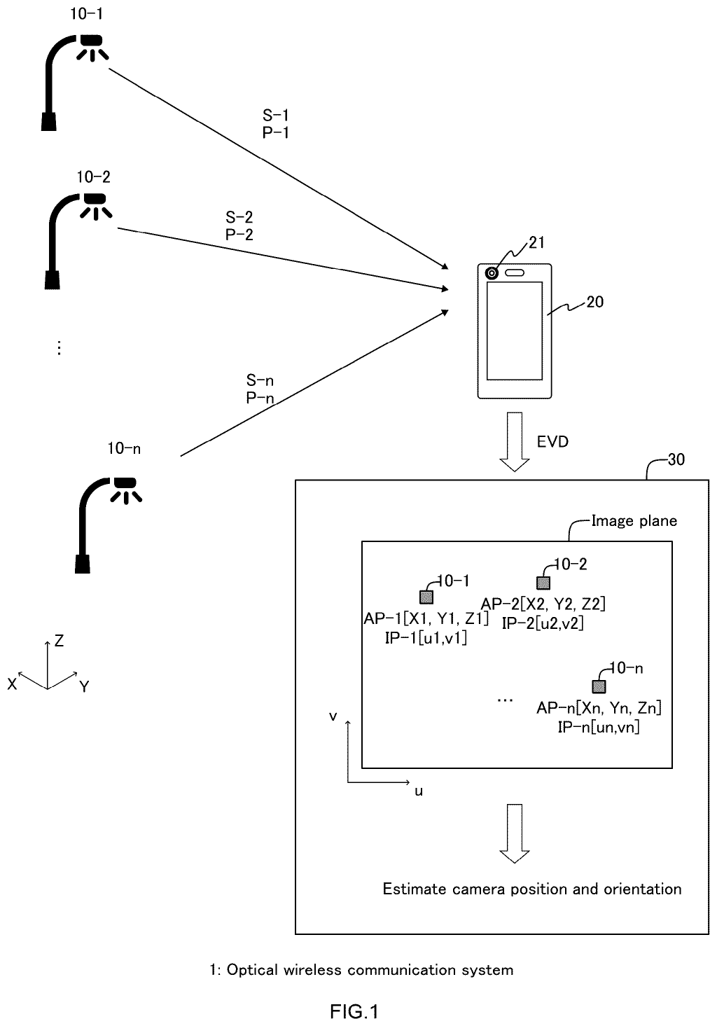

FIG. 1 is a diagram illustrating an overview of an optical wireless communication system 1 according to the present embodiment. The optical wireless communication system 1 includes a plurality of light sources 10-1 to 10-n (n is an integer satisfying n≥2), a receiving device 20 including an event camera 21, and an information processing device 30.

The plurality of light sources 10-1 to 10-n are fixedly attached in a space and installed indoors and outdoors. Examples of the plurality of light sources 10-1 to 10-n include a visible light emitting diode (LED) and an infrared LED. Since the visible light LED is widely used for streetlights, interior lights, traffic signals, electric bulletin boards, etc., the use of the visible light LED in the optical wireless communication system 1 leads to effective use of existing facilities. Since the visible light LED repeats blinking at a high speed that cannot be sensed by human eyes, the visible light can be used as a communication signal by controlling the blinking. In some embodiments, the plurality of light sources 10-1 to 10-n are included in the angle of view of the event camera 21 at the same time.

A light source 10-i (i=1 to n) constituting the plurality of light sources 10-1 to n transmits an optical wireless communication signal S-i by blinking. The optical wireless communication signal S-i includes position specifying information P-i for specifying a light source absolute position AP-i indicating the position of the light source 10-i as a transmission source in the absolute coordinate system. In the drawings, the absolute coordinate system is represented by an X-axis, a Y-axis and a Z-axis. The light source absolute position AP-i of the light source 10-i is expressed as [Xi, Yi, Zi]. Hereinafter, the “optical wireless communication signal S-i” is simply referred to as an “optical signal S-i” for the sake of simplicity.

The receiving device 20 receives the optical signal S-i through the event camera 21. In some embodiments, the receiving device 20 receives the optical signals S-1 to S-n transmitted from the plurality of light sources 10-1 to 10-n at the same time. Typical examples of the receiving device 20 are smartphones, tablets, wearable terminals for augmented reality, etc. In addition, any object including the event camera 21 can function as the receiving device 20. For example, a vehicle, a robot, a wheelchair, a stick, etc. with the event camera 21 may function as the receiving device 20. As described above, the receiving device 20 is typically an object or a terminal that is not fixed in a space. In other words, in some embodiments, the receiving device 20 is configured to be movable. When the receiving device 20 moves, the event camera 21 also moves accordingly.

The event camera 21 includes an event-based vision sensor (EV sensor). The EV sensor observes luminance changes of light received by pixels (image sensor elements) in the EV sensor. When the EV sensor observes a luminance change equal to or greater than a preset threshold, the EV sensor detects the luminance change as an “event”. An event is detected when a situation different from the previous situation occurs. For example, when an object or the event camera 21 moves, the relative position between the object and the event camera 21 changes, and the subject appears in new pixels where the subject has not existed. At this time, a significant luminance change occurs in pixels around the object, and therefore, the luminance change is detected as an event. Accordingly, the optical signal S-i is also detected as an event because the optical signal S-i causes a luminance change due to blinking of the light source 10-i.

The event camera 21 outputs data regarding pixels in which events are detected, as event data EVD. The event data EVD includes at least coordinates on an image plane of a pixel at which an event has occurred, a time at which the event has been detected, and a light and dark polarity (positive/negative). The threshold referred to by the sensor when detecting a luminance change is flexibly set. When an event occurs, a threshold value on the positive side (change in the light direction) and a threshold on the negative side (change in the dark direction) are set from a voltage (reference voltage) with reference to the luminance level at that time. A voltage change exceeding the threshold on the positive side is detected as an event of positive polarity, and a voltage change exceeding the threshold on the negative side is detected as an event of negative polarity. That is, the optical signal S-i is detected by the EV sensor as an event of positive polarity at the timing when the light source 10-i is turned on, and as an event of negative polarity at the timing when the light source 10-i is turned off.

The information processing device 30 acquires the event data EVD from the event camera 21. The information processing device 30 acquires the two-dimensional position of the optical signal S-i on the image plane using the event data EVD. This two-dimensional position indicates the position of the light source 10-i projected onto the image plane. Hereinafter, the position where the light source 10-i is projected on the image plane is referred to as a “light source image position IP-i”, and the process of acquiring the light source image position IP-i is referred to as “light source image position acquisition”. In the present disclosure, the image plane coordinate system is represented by a u-axis and a v-axis. The light source image position IP-i of the light source 10-i is represented as [ui, vi]. The information processing device 30 may be included in the receiving device 20 or may be a device outside the receiving device 20.

The information processing device 30 acquires the three-dimensional position (light source absolute position AP-i) of the light source 10-i in the absolute coordinate system from the position specifying information P-i included in the optical signal S-i. Hereinafter, the process of acquiring the light source absolute position AP-i is referred to as “light source absolute position acquisition”. Specific examples of the position specifying information P-i and the light source absolute position acquisition will be described later.

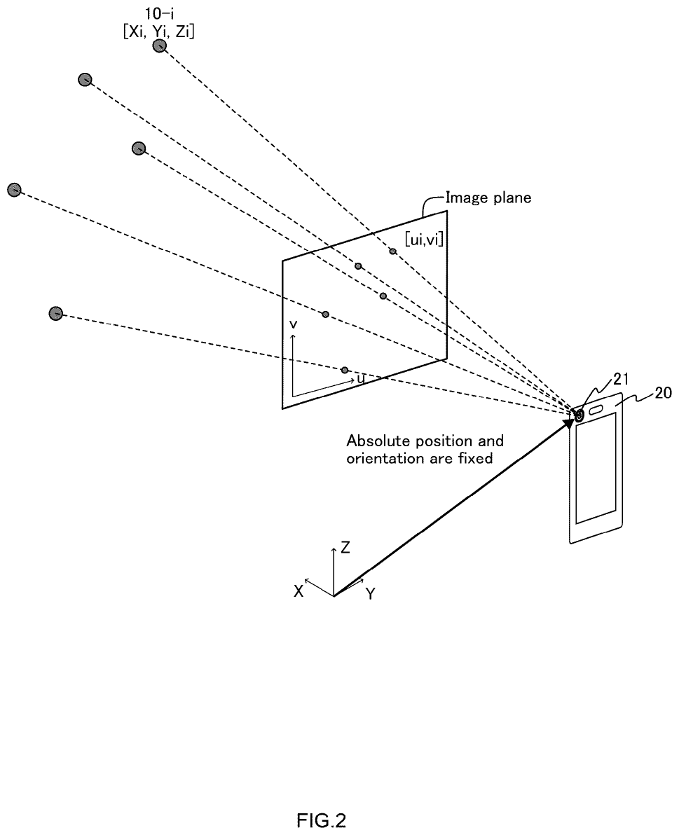

Through the above-described process, the information processing device 30 acquires n data sets of the light source absolute position AP-i ([Xi, Yi, Zi] in FIG. 1) and the light source image position IP-i ([ui, vi] in FIG. 1) regarding the light source 10-i. FIG. 2 is a perspective view showing the geometric relationship between the light source absolute position AP-i and the light source image position IP-i. The information processing device 30 estimates the position and orientation of the event camera 21 in the absolute coordinate system from the geometric relationship between the n data sets. More specifically, a rotation matrix and a translation vector are obtained from n data sets. A specific solution is known as a perspective n point (PnP) problem, and the value of the number of data sets (i.e., n) required to solve this problem varies depending on the method. For example, a method called an eight-point algorithm is known as one of the solutions to such a problem. Since the event camera 21 is provided in the receiving device 20, estimating the absolute position and orientation of the event camera 21 is equivalent to estimating the absolute position and orientation of the receiving device 20.

As described above, the information processing device 30 estimates the absolute position and orientation of the event camera 21 through the light source image position acquisition and the light source absolute position acquisition. This series of processes is hereinafter referred to as “camera position estimation”. Existing position estimation systems (for example, satellite positioning systems) may not be able to accurately perform positioning in places where satellite radio waves do not easily reach (inside buildings, underground, between high-rise buildings, etc.). On the other hand, the camera position estimation by the optical wireless communication system 1 does not use satellite radio waves and thus can be applied to a variety of places.

### 2. Camera Position Estimation

Hereinafter, a series of processes related to the camera position estimation will be described in detail.

### 2-1. Light Source Image Position Acquisition

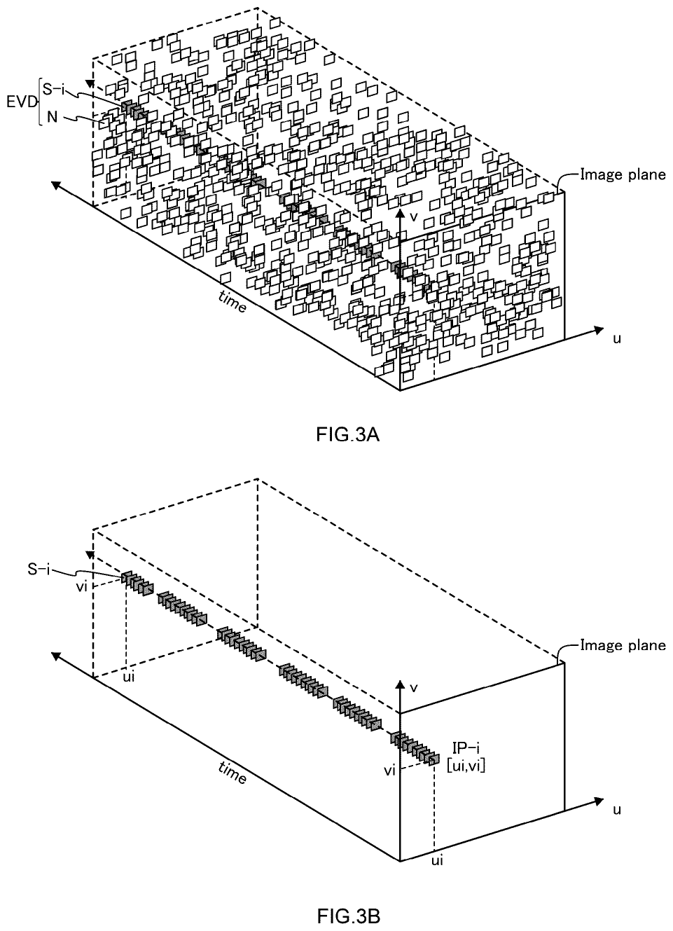

FIGS. 3A and 3B are schematic diagrams showing a process of light source image position acquisition.

FIGS. 3A and 3B are graphs showing a space-time distribution of the event data EVD received by the information processing device 30 from the event camera 21. The event data EVD includes noise N, an event caused by movement of the object or the event camera 21, in addition to an event caused by blinking of the light source 10-i (that is, the optical signal S-i). That is, the event data EVD is output in a state in which the optical signal S-i, necessary for the camera position estimation, and the noise N, unnecessary for the camera position estimation, are mixed. Therefore, signal separation to separate the optical signal S-i and the noise N is required for the information processing device 30 to acquire the light source image position IP-i.

One method of the signal separation is based on the “data frequency” of the event data EVD for each pixel. As described above, the event data EVD includes the time at which the event is detected. Therefore, the information processing device 30 can calculate the number of event data EVD detected per unit time for each pixel. The number of event data EVD detected per unit time can be referred to as a “data frequency”.

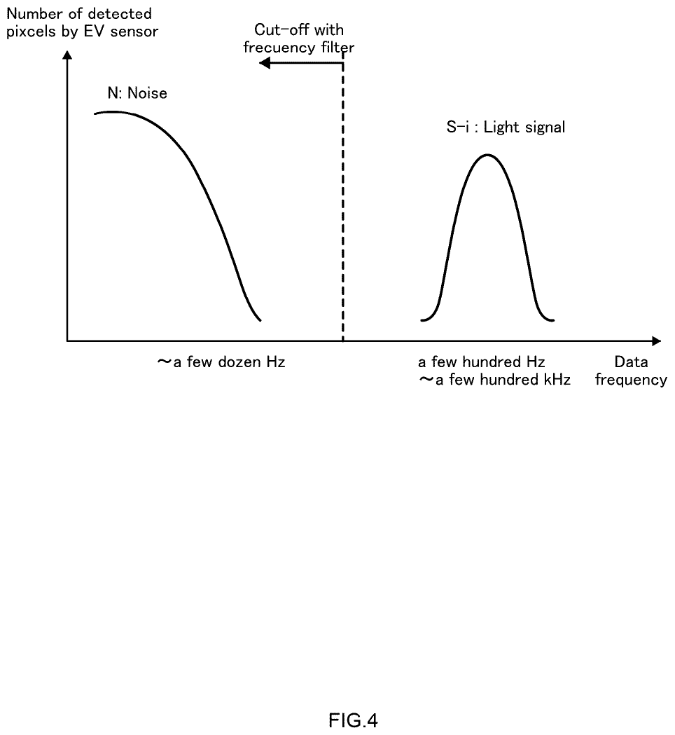

As shown in FIG. 4, the characteristics of the optical signal S-i and the noise N are significantly different at the data frequency. The data-frequency of optical signal S-i depends on the blinking frequency of the light source 10-i, and the value is about a few hundred Hz to a few hundred kHz. On the other hand, the noise N caused by the movement of the object or the event camera 21 is significantly smaller (a few dozen Hz) than the optical signal S-i. Therefore, the information processing device 30 can separate the optical signal S-i and the noise N with a frequency filter. An example of the frequency filter is a high-pass filter that cuts off a signal having a frequency equal to or lower than a preset frequency. In this case, the information processing device 30 determines that a pixel region in which a high data frequency that is not cut by the high-pass filter is observed is a signal region occupied by the optical signal S-i.

FIG. 3B is a graph showing the space-time distribution of the event data EVD after the signal separation. As described above, since the event data EVD includes information of coordinates on the image plane coordinate system, the information processing device 30 can acquire the position of the separated optical signal S-i on the image plane coordinate system. The position of the light signal S-i on the image plane coordinate system indicates the position where the light source 10-i is projected onto the image plane coordinate system, that is, the light source image position IP-i. In practice, since the signal region occupied by the optical signal S-i on the image plane spreads over a plurality of pixels, for example, the center coordinates of the signal region of the optical signal S-i may be regarded as the light source image position IP-i. In this way, the light source image position acquisition is executed.

### 2-2. Light Source Absolute Position Acquisition

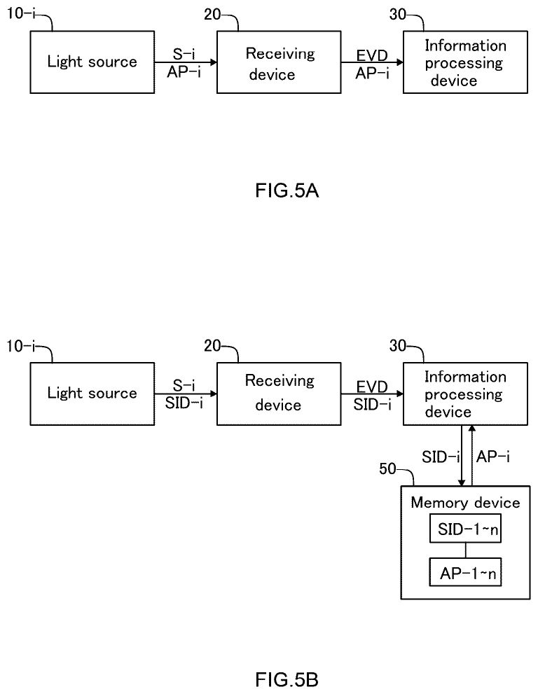

FIGS. 5A and 5B are schematic diagrams illustrating some examples of light source absolute position acquisition. As described above, the optical signal S-i transmitted from the light source 10-i includes the position specifying information P-i for specifying the light source absolute position AP-i.

In FIG. 5A, the optical signal S-i transmitted from the light source 10-i includes the light source absolute position AP-i as the position specifying information P-i. The receiving device 20 receives the optical signal S-i via the event camera 21. The receiving device 20 passes the event data EVD output by the event camera 21 to the information processing device 30. Since the contents of the light signal S-i are recorded as a luminance change in the event data EVD, the information processing device 30 acquires the position specifying information P-i, that is, the light source absolute position AP-i, based on the event data EVD.

FIG. 5B, the optical signal S-i includes identification information SID-i that is information for identifying the light source 10-i. In this case, the optical wireless communication system 1 further includes a memory device 50. The memory device 50 stores the light source absolute positions AP-1 to AP-n of the plurality of light sources 10-1 to 10-n, in association with the identification information SID-1 to SID-n of the plurality of light sources 10-1 to 10-n. The information processing device 30 accesses the memory device 50 and acquires the light source absolute position AP-i corresponding to the identification information SID-i. The memory device 50 may be included in the information processing device 30 or may be an external device different from the information processing device 30. The memory device 50 may be managed by a management server, and the information processing device 30 may acquire the light source absolute position AP-i through communication with the management server.

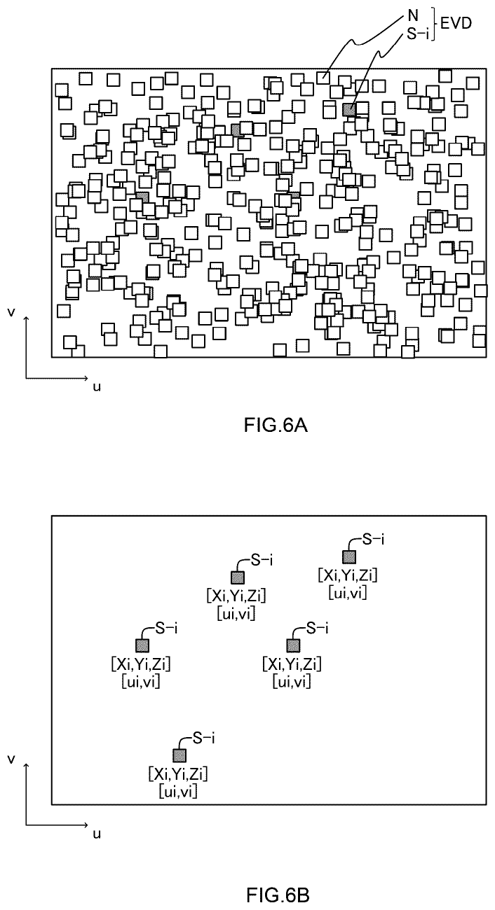

FIGS. 6A and 6B are diagrams showing image planes before and after the light source image position acquisition and the light source absolute position acquisition. FIG. 6A shows the image plane before the light source image position acquisition and the light source absolute position acquisition are executed, that is, at the time when the information processing device 30 acquires the event data EVD. At this step, the event data EVD includes the noise N together with the plurality of optical signals S-1 to S-n transmitted from the plurality of light sources 10-1 to 10-n.

The information processing device 30 executes the signal separation to the optical signal S-i and the noise N, and acquires the position of the optical signal S-i in the image plane coordinate system, that is, the light source image position IP-i of the light source 10-i. The information processing device 30 acquires the light source absolute position AP-i of the light source 10-i through the light source absolute position acquisition. As a result of the light source image position acquisition and the light source absolute position acquisition, the information processing device 30 acquires a data set of the light source absolute position AP-i and the light source image position IP-i with respect to the light source 10-I, as illustrated in FIG. 6B. The information processing device 30 can estimate the position and orientation of the event camera 21 in the absolute coordinate system from the geometric relationship based on the data sets and the focal distance of the event camera 21.

### 2-3. Effect

As described above, the receiving device 20 in the optical wireless communication system 1 includes the event camera 21. The event camera 21 detects only information on pixels in which luminance changes equal to or greater than a threshold is detected, and outputs the information as event data EVD. A frame-based sensor built in a normal camera outputs information of all pixels as an image at a predetermined time interval (frame rate), and thus the amount of data tends to be large. On the other hand, the event camera 21 outputs only information of pixels in which luminance changes occur, and thus can efficiently detect the optical signal S-i. Therefore, the amount of data of the event data EVD is smaller than the amount of image data output by a normal camera. The small amount of data makes the time required to output the data short, and thus the event camera 21 has a higher temporal resolution than a normal camera has.

Since the event camera 21 has a high temporal resolution, the event data EVD is output at a high speed. However, since the data amount of the event data EVD is small, the information processing device 30 can process the event data EVD at a sufficient speed even if the information processing device 30 does not have particularly high performance. It is assumed that the information processing device 30 processes image data (by a frame-based sensor) output at a speed substantially equal to that of the event data EVD in a time substantially equal to that of the event data EVD. In this case, the information processing device 30 is required to have processing performance higher than that required to process the event data EVD. This means that the optical wireless communication system 1 can estimate the camera position even if the information processing device 30 does not have a particularly high process performance.

It is more effective to use a visible light source as the plurality of light sources 10-1 to 10-n. One of the aspects of using a visible light source is that it is commonly used as existing equipment (streetlights, room lights, traffic lights, electric bulletin boards, etc.), and thus the investment in equipment for use is low. However, since the frequency of visible light is higher than that of radio waves or infrared rays, there is a concern that the data frequency cannot be measured by a normal camera. On the other hand, since the event camera 21 has a high temporal resolution as described above, a synergistic effect can be expected by combining the event camera 21 with visible light having a high frequency.

Furthermore, in the optical wireless communication system 1, even when the event camera 21 moves, tracking process to the images of the plurality of light sources 10-1 to 10-N is not required.

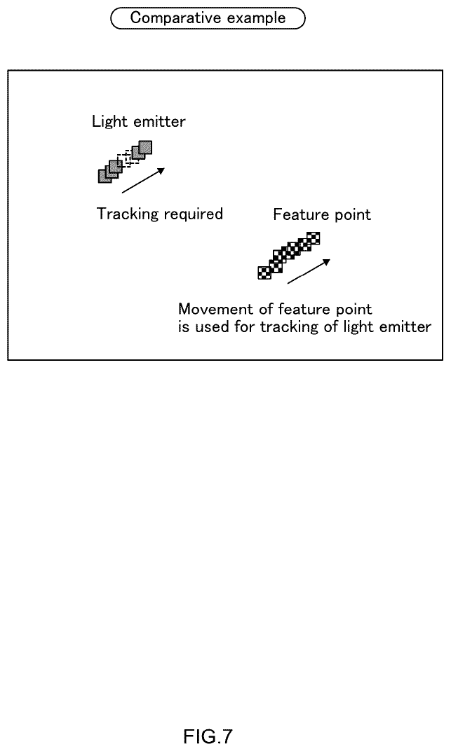

Patent Literature 1 is considered as a comparative example for a case where a camera moves in a system that estimates a position and an orientation from an image of the camera. FIG. 7 is a diagram showing a comparative example. Patent Literature 1 discloses a technique for estimating the position and orientation of a camera using a fixed blinking light emitter and a camera (frame-based camera). Further, when the camera moves, the blinking pattern of the same light emitter is detected by tracking the light emitter moving in the image. The system disclosed in Patent Literature 1 predicts where the light emitter detected in a frame appears in the next frame, and associates the light emitter with a light emitter located within a predetermined range from the detection position predicted in the next frame. The tracking process of each light emitter is realized in the system in Patent Literature 1. Tracking in image processing may require a large processing load.

On the other hand, in the optical wireless communication system 1, high-speed communication is possible by receiving high-speed blinking of the plurality of light sources 10-1 to 10-n by the event camera 21 having high temporal resolution. That is, since the camera position estimation is completed in an extremely short time, the data frequency of each pixel may be simply continuously measured, regardless of the movement of the plurality of light sources 10-1 to 10-n on the image plane. That is, since tracking process is not required in the optical wireless communication system 1, it is possible to reduce the processing load generated in the information processing device 30. This leads to further reduction in the process performance required for the information processing device 30.

In addition, in Patent Literature 1, a feature point, which is not blinking, fixed in the photographing space, and has a fixed luminance is required. This feature point is necessary for stable tracking to the light emitter. Since the feature point does not blink, stable tracking is possible. In Patent Literature 1, as shown in FIG. 7, the accuracy of tracking of the light emitter is improved by utilizing the premise that the movement of the light emitter on the image and of the feature point on the image are synchronized. For example, if there were no feature point, it is difficult to track the light emitter during a frame in which the light emitter is off and to calculate a position at which the light emitter appears when the light emitter is turned on next. Therefore, in Patent Literature 1, the position where the light emitter appears after being turned on next is predicted by using tracking of the feature point. That is, the feature point is unnecessary for the optical wireless communication system 1, which does not require tracking, since it is necessary for stably tracking the light emitter. The optical wireless communication system 1 reduces the number of components necessary for camera position estimation by using the event camera 21.

### 3. Configuration Example of Optical Communication System

### 3-1. First Example

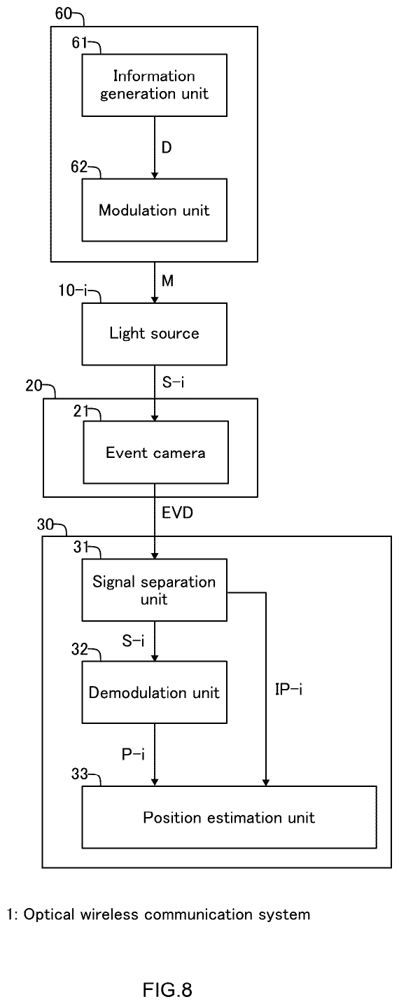

FIG. 8 is a block diagram illustrating a first configuration example of the optical wireless communication system 1.

The blinking control device 60 controls the blinking pattern of the light source 10-i. The blinking control device 60 may be built in each of the equipment (street light, room light, etc.) including the light source 10-i. The blinking control device 60 may be included in an external equipment, such as management server, controlling the blinking of the light source 10-i from the outside. Further, when the blinking control device 60 is provided in external equipment, the blinking control device 60 may control the blinking of the plurality of light sources 10-1 to 10-n in an integrated way.

The information generation unit 61 generates a digital signal D. The digital signal D is a signal representing the position specifying information P-i by two values of “0” and “1”. The generated digital signal D is output to the modulation unit 62.

The modulation unit 62 modulates the digital signal D into a signal suitable for optical wireless communication to generate a modulation signal M. A pulse width modulation (PWM) method, a pulse position modulation (PPM) method, etc. are used as the modulation method. The PWM method is a method of changing the time ratio between ON (lighting) and OFF (extinction) of the light source 10-i by an input signal. The PPM method is a modulation system in which the position of a carrier pulse on the time axis is changed by an input signal.

The blinking control device 60 passes the modulation signal M to the light source 10-i. The light source 10-i blinks in accordance with the modulation signal M. The optical signal S-i is a signal indicating a blinking pattern of the light source 10-i represented by the modulation signal M.

The receiving device 20 receives the optical signal S-i through the event camera 21. Specifically, the EV sensor built in the event camera 21 detects a luminance change derived from the optical signal S-i as an event. The receiving device 20 transmits the event data EVD to the signal separation unit 31 in the information processing device 30.

In FIG. 8, the information processing device 30 is a device different from the receiving device 20 (for example, an external server). That is, the receiving device 20 transmits the event data EVD to the information processing device 30, located outside. The information processing device 30 executes a series of subsequent processes based on the received event data EVD.

The signal separation unit 31 acquires the light source image position IP-i by performing a process to separating the optical signal S-i and the noise N included in the event data EVD (the above-described signal separation). The light source image position IP-i is output to the position estimation unit 33.

The demodulation unit 32 demodulates the optical signal S-i separated by the signal separation unit 31 to acquire the position specifying information P-i. The demodulation unit 32 passes the position specifying information P-i to the position estimation unit 33.

The position estimation unit 33 acquires the light source absolute position AP-i based on the position specifying information P-i. For example, as shown in FIG. 5A, when the light source absolute position AP-i is directly transmitted as the position specifying information P-i, the position estimation unit 33 directly acquires the light source absolute position AP-i. In addition, as shown in FIG. 5B, when the identification information SID-i is transmitted as the position specifying information P-i, the information processing device 30 accesses the memory device 50 and acquires the light source absolute position AP-i corresponding to the identification information SID-i. The information processing device 30 acquires n data sets of the light source absolute position AP-i and the light source image position IP-i with respect to the light source 10-i. The information processing device 30 estimates the position and orientation of the event camera 21 in the absolute coordinate system from the geometric relationship between the n data sets.

### 3-2. Second Example

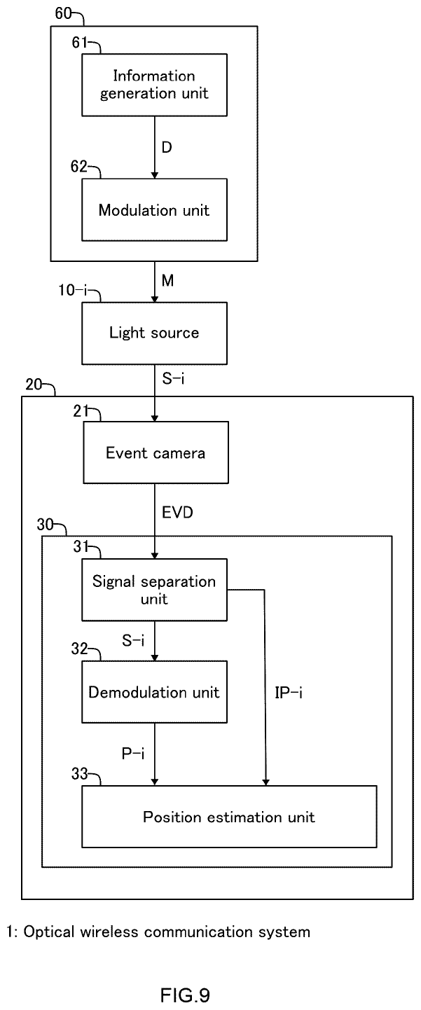

FIG. 9 is a block diagram illustrating a second configuration example of the optical wireless communication system 1. The basic configuration is common to the example of FIG. 8. In the example of FIG. 9, the information processing device 30 is built in the receiving device 20. In this case, after receiving the optical signal S-i, the receiving device 20 can complete the camera position estimation inside the receiving device 20.

### 3-3. Other Examples

In addition to the embodiment described above, a variety of cases are considered for the configuration of the receiving device 20 and the information processing device 30. For example, the functions of the signal separation unit 31 and the demodulation unit 32 may be included in the receiving device 20, and the function of the position estimation unit 33 may be included in the information processing device 30 outside the receiving device 20.

What is claimed is:

1. An optical wireless communication system comprising:
a plurality of light sources;
a receiving device including an event camera; and
an information processing device, wherein
each light source is configured to transmit an optical wireless communication signal,
the receiving device is configured to receive the optical wireless communication signal through the event camera,
the optical wireless communication signal includes position specifying information, for specifying a position of a transmission source of the optical wireless communication signal in an absolute coordinate system, and
the information processing device is configured to:
acquire a light source image position indicating a position of each light source projected on an image plane coordinate system of an image plane obtained by the event camera, by specifying a signal region of the optical wireless communication signal on the image plane coordinate system;
acquire a light source absolute position indicating a position of each light source in the absolute coordinate system, based on the position specifying information included in the optical wireless communication signal; and
estimate a position and an orientation of the event camera in the absolute coordinate system, using the light source image position and the light source absolute position.

2. The optical wireless communication system according to claim 1, wherein
the information processing device is configured to specify the signal region on the image plane coordinate system, based on a frequency of event data for each pixel of the image plane obtained by the event camera.

3. The optical wireless communication system according to claim 1, wherein
the position specifying information includes the light source absolute position of each light source.

4. The optical wireless communication system according to claim 1, further comprising a memory device, wherein
the memory device is configured to store at least:
identification information for identifying each light source; and
the light source absolute position of each light source,
the position specifying information includes the identification information of each light source, and
the information processing device is configured to acquire the light source absolute position, corresponding to the identification information included in the position specifying information, from the memory device.

5. The optical wireless communication system according to claim 1, wherein
the receiving device is configured to be movable.

6. A receiving device comprising:
an event camera; and
an information processing device configured to receive an optical wireless communication signal transmitted from each of a plurality of light sources through the event camera, wherein
the optical wireless communication signal includes position specifying information, for specifying a position of a transmission source of the optical wireless communication signal in an absolute coordinate system, and
the information processing device is configured to:
acquire a light source image position indicating a position of each light source projected on an image plane coordinate system, by specifying a signal region of the optical wireless communication signal on the image plane coordinate system of an image plane obtained by the event camera;
acquire a light source absolute position indicating a position of each light source in the absolute coordinate system, based on the position specifying information included in the optical wireless communication signal; and
estimate a position and an orientation of the event camera in the absolute coordinate system, using the light source image position and the light source absolute position.

7. The receiving device according to claim 6, wherein
the information processing device is configured to specify the signal region on the image plane coordinate system, based on a frequency of event data for each pixel of the image plane obtained by the event camera.

8. The receiving device according to claim 6, wherein
the position specifying information includes the light source absolute position of each light source.

9. The receiving device according to claim 6, further comprising a memory device, wherein
the memory device is configured to store at least:
identification information for identifying each light source; and
the light source absolute position of each light source,
the position specifying information includes the identification information of each light source, and
the information processing device is configured to acquire the light source absolute position, corresponding to the identification information included in the position specifying information, from the memory device.

10. The receiving device according to claim 6, configured to be movable.
